(19) United States
(12) Patent Application Publication
(10) Pub. No.: US 2007/0114850 A1
(43) Pub. Date: May 24, 2007

(54) Power system and method for supplying electrical power to a load

(75) Inventors: John M. Fisher, Spokane, WA (US); Arthur Rocco, Newman Lake, WA (US)

Correspondence Address: WELLS ST. JOHN P.S., 601 W. FIRST AVENUE, SUITE 1300, SPOKANE, WA, 99201, US

(73) Assignee: Relion, Inc.

(21) Appl. No.: 11/282,122

(22) Filed: Nov. 18, 2005

(51) Int. Cl. H02J 7/00; H01M 8/04

(52) U.S. Cl. 307/65; 429/22; 320/138

(57) ABSTRACT

A power system and method of supplying electrical power to a load is disclosed and wherein the invention includes a plurality of serially electrically coupled DC power sources each having an electrical power output which is supplied to a load; a charge storage device electrically coupled with the plurality of DC power sources, and having a maximum electrical charge which is substantially equal to the electrical power output of one of the plurality of DC power sources; and means for electrically decoupling at least one of the plurality of DC power sources while simultaneously electrically discharging the charge storage device to the load.

### TECHNICAL FIELD

The present invention relates to a power system and a method for supplying electrical power to a load, and more specifically to a power system. having a plurality of DC power sources and which provides a smooth power output to a load when one of the DC power sources is intermittently electrically decoupled from the load.

### BACKGROUND OF THE INVENTION

In U.S. Pat. Nos. 6,030,718 and 6,468,682, a fuel cell power system is disclosed, and which includes a plurality of fuel cell modules which can be operably detached and removed from the fuel cell power system while the remaining fuel cell modules continue to operate; The removal of the fuel cell modules may be for purposes of repair, replacement or the like. Further, the electrical shunting of the same fuel cell modules as more fully disclosed in U.S. Pat. No. 6,096,449 is effective for increasing the performance of such fuel cell power systems.

As should be understood, when any of a plurality of DC power sources are intermittently and periodically interrupted, for whatever reason, (whether it be for shunting as disclosed in U.S. Pat. No. 6,096,449 or removed from the fuel cell power system as described more fully in the earlier patents noted above), a by-product of this process is a ripple or interruption in the overall power system output voltage caused by the periodic shorting of one or many modules. This ripple or momentary interruption in the output voltage must be, according to the prior art practices, smoothed out by a DC to DC power converter which then supplies the resulting DC voltage to the load.

While the prior art practice has operated with a great degree of success, it has shortcomings which have detracted from its usefulness. More specifically, the prior art practice as briefly described above increases the complexity and cost of a fuel cell power system by adding additional equipment to the fuel cell power system. While this additional equipment is somewhat costly, there are also power losses attendant with the use of equipment such as a DC to DC power converter.

A power system and method for supplying power to a load which avoids the shortcomings attendant with the prior art practices employed heretofore, is the subject matter of the present application.

### SUMMARY OF THE INVENTION

A first aspect of the present invention relates to a power system which includes a plurality of serially electrically coupled DC power sources each having an electrical power output which is supplied to a load; a charge storage device electrically coupled with the plurality of DC power sources, and having a maximum electrical charge which is substantially equal to the electrical power output of one of the plurality of DC power sources; and means for electrically decoupling at least one of the plurality of DC power sources while simultaneously electrically discharging the charge storage device to the load.

Another aspect of the present invention relates to a power system which includes a plurality of DC power sources which provide a source of electrical power to service a requirement of the load; a charge storage device having a maximum electrical charge which is less than the amount of electrical power which is necessary to service the requirement of the load; and means for selectively decoupling the individual DC power sources from the load while simultaneously electrically discharging, and electrically coupling the charge storage device to the load in a manner which provides uninterrupted electrical power to meet the electrical power requirement of the load.

Still another aspect of the present invention relates to a power system which includes a plurality of fuel cells each having a predetermined electrical power output, and which are serial electrically coupled together, and which produce a cumulative power output which substantially meets the electrical power requirements of the load; a controller which is electrically coupled with the respective plurality of fuel cells, and which periodically electrically decouples individual fuel cells from the load; and a charge storage device which is electrically coupled with the controller, and which is selectively electrically coupled to the load when the controller electrically decouples one of the plurality of fuel cells from the load, and wherein the charge storage device provides an amount of electrical power to the load which is not greater than the electrical power output of the decoupled fuel cell.

Yet still another aspect of the present invention relates to a power system which includes a plurality of fuel cells which each have anode and cathode, and which, when rendered operable, supply electrical power of a given amount to meet the electrical power requirements of a load; a controller electrically coupled to the anode and cathode of each of the fuel cells, and which is operable to periodically shunt the anode to the cathode of each of the respective fuel cells, and wherein the shunting of the respective fuel cells results in a reduced amount of electrical power provided to the load; and a charge storage device which is controlled by the controller and which is periodically electrically coupled to the load during the shunting of the respective fuel cells, and which is operable to deliver electrical power which is substantially equal to the reduced amount of electrical power as caused by the shunting.

Moreover, another aspect of the present invention relates to a method for supplying electrical power to a load which includes the steps of providing a plurality of fuel cells which individually produce an electrical power output; serially electrically coupling the plurality of fuel cells together to provide a resulting electrical power output which is not greater than the electrical power requirements of a load; supplying the resulting electrical power output of the serially electrically coupled fuel cells to the load; providing a controller which is controllably electrically coupled to the respective plurality of fuel cells; periodically electrically decoupling at least one of the fuel cells from the plurality of serially electrically coupled fuel cells with the controller; providing a charge storage device which is selectively electrically coupled with resulting electrical power output of the plurality of fuel cells, and the load, and which is controllably electrically coupled with the controller; electrically charging the charge storage device to a maximum charge with the resulting electrical power output while the plurality of fuel cells simultaneously meet the electrical needs of the load; and electrically discharging the charge storage device during a time period where the controller has electrically decoupled at least one of the fuel cells from the plurality of fuel cells, and wherein the discharged charge storage device provides electrical power in an amount which is substantially equal to the electrical power output of the electrically decoupled fuel cell.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a greatly simplified depiction of the power system of the present invention.

FIG. 2 is a greatly simplified depiction of a portion of the circuitry employed in the present invention and which is shown in a first electrical state.

FIG. 3 is a greatly simplified depiction of a portion of the circuitry employed in the present invention and which is shown in a second electrical state.

FIG. 4 is a greatly simplified depiction of a portion of the circuitry employed in the present invention and which is shown in a third electrical state.

FIG. 5 is a greatly simplified depiction of a portion of the circuitry employed in the present invention and which is shown in a fourth electrical state.

FIG. 6 is a greatly simplified depiction of a portion of the circuitry employed in the present invention and which is shown in a fifth electrical state.

FIG. 7 is a graphical depiction of the power output provided by a plurality of DC power sources and which is seen by a load when individual DC power sources are electrically decoupled from the load.

FIG. 8 is a graphical depiction showing the DC power output of a plurality of DC power sources provided to a load employing the features of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

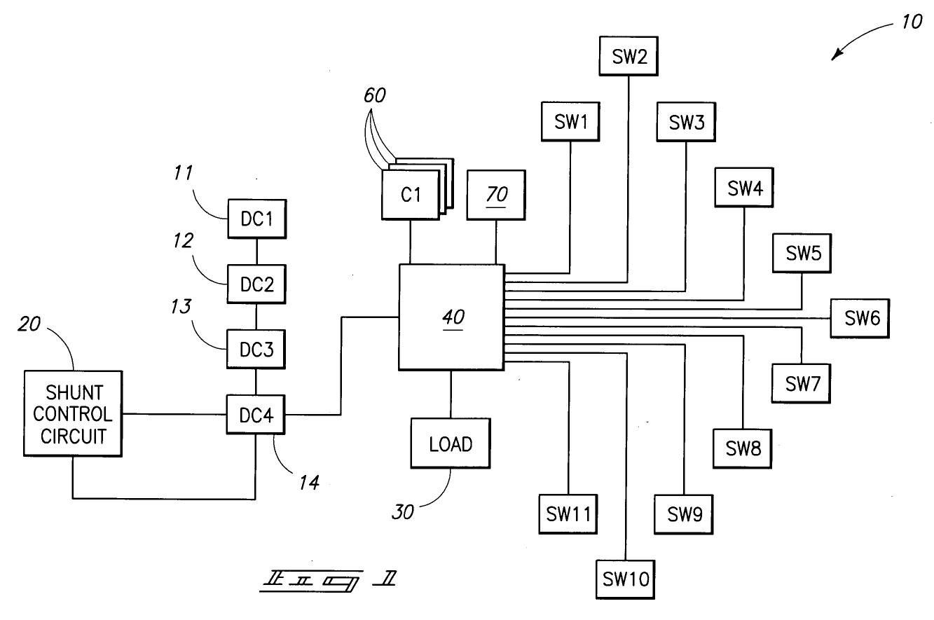

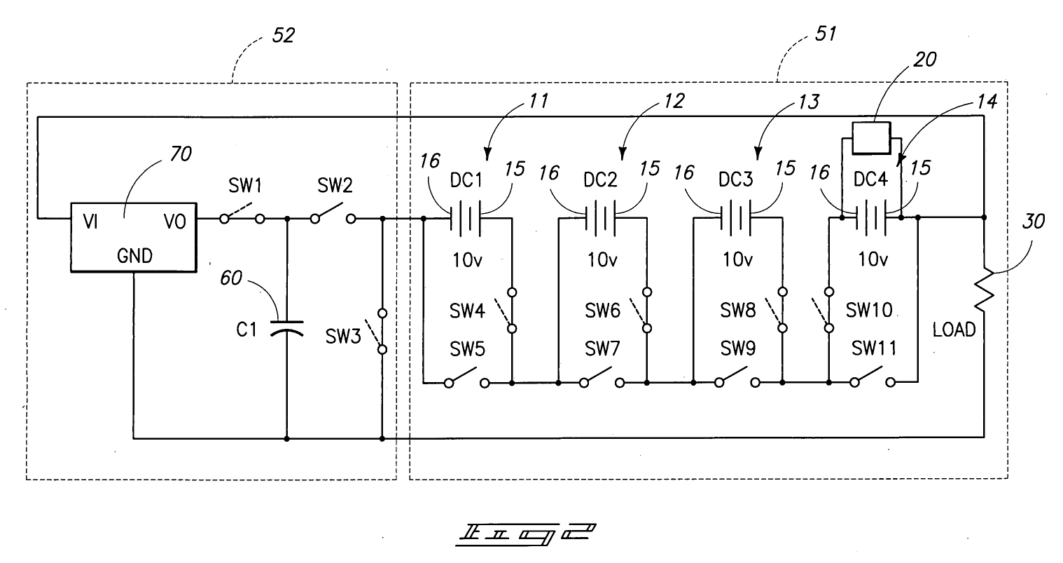

Referring now to FIGS. 1 and 2, the present invention relates to a power system and a method for supplying electrical power to a load, and which is generally indicated by the numeral 10. As seen therein, the present invention 10 includes, as seen in FIG. 1 and 2, for example, a plurality of serially electrically coupled DC power sources each having an electrical power output which is supplied to a load. The plurality of DC power sources are herein indicated as first, second, third and fourth DC power sources DC1-DC4 and which are indicated by the numerals 11, 12, 13, and 14, respectively. Each of the plurality of DC power sources may have substantially the same electrical power output, or alternatively may have different electrical power outputs. Still further, the respective individual DC power sources may include fuel cells having multiple modules as described in prior art U.S. Pat. Nos. 6,030,718 and 6,468,682. The teachings of these patents are incorporated by reference herein. Further, and as seen in FIG. 1, one of the DC power sources, that being 14, may include shunt control circuitry 20 similar to that described in U.S. Pat. No. 6,096,449 and which periodically shunts the electrical power output of individual fuel cell modules, for example, in order to increase the performance of same. The individual DC power sources 11-14, respectively, each provide an electrical power output which is supplied to a load 30 in order to energize same. The present invention 10 further includes a controller 40 which is controllably electrically coupled to the respective plurality of DC power sources 11-14, and in electrical sensing relation relative to the load 30. The controller 40 provides a means for electrically decoupling at least one of the plurality of DC power sources 11-14 from the load 30 for the purposes which will be described in greater detail hereinafter.

It will be seen from a study of, for example, FIG. 2, and following, that the present invention 10 includes first circuitry 51 for serially electrically coupling the plurality of DC power outputs of the plurality of DC power sources 11-14, respectively, to the load 30. The first circuitry 51 is further operable to selectively electrically disconnect or decouple individual DC power sources from the load 30, as will be described in greater detail, hereinafter. The present invention 10 further includes, in addition to the first circuitry 51; second circuitry 52 which is electrically coupled to the first circuitry 51, and which supplies a portion of the DC power provided by the plurality of DC power sources 11-14 to electrically charge a charge storage device which is generally indicated by the numeral 60. Still further, the controller 40, in combination with the second circuitry 52, electrically discharges the charge storage device 60 when at least one of the plurality of DC power sources 11-14 is electrically disconnected or decoupled from the load 30 by means of the controller 40 acting upon the first circuitry 51. As should be appreciated from a study of FIGS. 1 and 2, the first and second circuitry 51 and 52 is electrically controlled by means of the controller 40. In addition to the foregoing, the present invention 10 includes a charging circuit which is generally indicated by the numeral 70, and which is further made integral with the second circuitry 52. The charging circuit 70 is of conventional design, and is operable to provide a charging current which is supplied to the charge storage device 60. In the arrangement as seen in FIG. 1, and following, the charge storage device 60 may comprise a plurality of charge storage devices. If a plurality of charge storage devices is provided, the controller 40 is operable to select the appropriate number of charge storage devices to electrically discharge in order to provide a cumulative amount of electrical power which is then supplied to the first circuitry which is electrically coupled to the load 30 and which replaces the amount of DC power which has been disconnected from the load 30.

In the arrangement as seen in FIG. 1 and following, the controller 40 which represents the means for electrically decoupling the individual DC power sources from the load 30, is further electrically coupled with the first and second circuitry 51 and 52, and further is disposed in electrical charge sensing relation relative to the charge storage device 60, and is additionally in electrical power output sensing relation relative to the individual DC power sources 11-14, respectively. In this arrangement, the controller 40 provides a convenient means for selectively decoupling the individual DC power sources 11-14 from the load 30, while simultaneously electrically discharging and electrically coupling the charge storage device 60 to the load 30 in a manner which provides uninterrupted electrical power to meet the electrical power requirements of the load. This is best understood by a study of FIG. 8.

Referring now to FIG. 1, the present invention 10 includes a plurality of switches here indicated as SW1-SW11, respectively, and which are made integral with the respective first and second circuitry 51 and 52, respectively as seen in FIG. 2. As noted above, the first and second circuitry 51 and 52 are electrically coupled together in a fashion to provide the features of the invention and which have been described herein. As seen in FIG. 1, the respective switches are controllably electrically coupled by the controller 40 to alternately place them into the open or closed electrical state as will be described below. As will be seen by a study of FIG. 2 and following, switch SW4-SW11 are incorporated within the first circuitry 51; and SW1-SW3 are incorporated within the second circuitry 52. It should be understood that an actual power system could include many more switches if more than four DC power sources are employed.

As seen in FIGS. 2 and following, the power system 10 of the present invention includes a plurality of serially electrically coupled DC power sources 11-14 each having a DC electrical power output which is supplied to a load 30. Still further, the power system 10 includes a charge storage device 60 which is electrically coupled with the plurality of DC power sources, and which has a maximum electrical charge which is substantially equal to the electrical power output of at least one of the plurality of DC power sources 11-14. Still further, the power system 10 includes a means 40 (FIG. 1) which acts upon the first circuitry 51 and which electrically decouples at least one of plurality of DC power sources 11-14 while simultaneously electrically discharging the charge storage device 60 to the load 30. As earlier described, the plurality of DC power sources 11-14 may have substantially the same electrical power output or further may have different electrical power outputs. Additionally, a plurality of DC power sources may comprise a plurality of fuel cells which have substantially the same electrical output or different electrical outputs. In the arrangement as seen, in FIG. 1 and 2, for example, the charge storage device 60 may include a plurality of charge storage devices, and wherein the means 40 for electrically decoupling the plurality of DC power sources decouples a plurality of DC power sources from the load while simultaneously electrically discharging a number of charge storage devices 60 by means of the second electrical circuitry 52, and which has an accumulative electrical charge which is substantially equal to the cumulative electrical power output previously provided by the electrically disconnected DC power sources 11-14.

As should be understood, the charge storage device 60 may comprise a battery, or an ultracapacitor which are well understood in the art. It should be further understood that the power system 10 of the present invention includes first circuitry 51 for serially electrically coupling the plurality of DC power outputs of the plurality of DC power sources 11-14 to the load 30. The first circuitry is further operable by means of the controller 40 to selectively electrically disconnect or decouple the individual DC power sources from the load 30. Still further, the present invention 10 includes second circuitry 52 which is electrically coupled to the first circuitry, and which supplies a portion of the DC power output provided by the plurality of DC power sources 11-14 to electrically charge the charge storage device 60. Additionally, the second circuitry 52 electrically discharges the charge storage device by means of the controller 40 when at least one of the plurality of DC power sources 11-14 is electrically disconnected from the load 30.

In another aspect of the present invention, the power system 10 includes a plurality of DC power sources 11-14 which provide a source of electrical power to service a requirement of a load 30; and a charge storage device 60 having a maximum electrical charge which is less than the amount of electrical power which is necessary to service the requirement of the load 30. Still further, the power system 10 includes a means 40 for selectively decoupling the individual DC power sources from the load 30 while simultaneously electrically discharging and electrically coupling the charge storage device 60 to the load 30 in a manner which provides uninterrupted electrical power to meet the electrical power requirements of the load. This is best understood by reference to FIG. 8.

In the arrangement as seen in FIG. 2 and following, the respective plurality of DC power sources 11-14 each produce an electrical power output, and wherein the maximum electrical charge of the charge storage device 60 is substantially equal to the electrical power output of the DC power sources 11-14 which have been selectively decoupled from the load 30. In the event that there is a plurality of charge storage devices 60, the means 40 for selectively decoupling the individual DC power sources from the load simultaneously electrically discharges a given number of charge storage devices 60 which have an accumulative electrical charge which is substantially equal to the power output of the DC power sources 11-14 which have been selectively disconnected from the load 30 by means of the controller 40. In the event that the DC power sources comprise a plurality of fuel cells, for example, it should be understood that each fuel cell has an anode and a cathode 15 and 16, respectively, and the means 40 for selectively electrically decoupling the individual DC power sources 11-14 comprises a controller 40 which shunts the anode to the cathode of at least one of the plurality of DC power sources 11-14, respectively. This is achieved by means of the shunt control circuit 20 as seen in FIGS. 1. The shunt control circuit is more fully described in U.S. Pat. No. 6,096,449, the teachings of which are incorporated by reference herein.

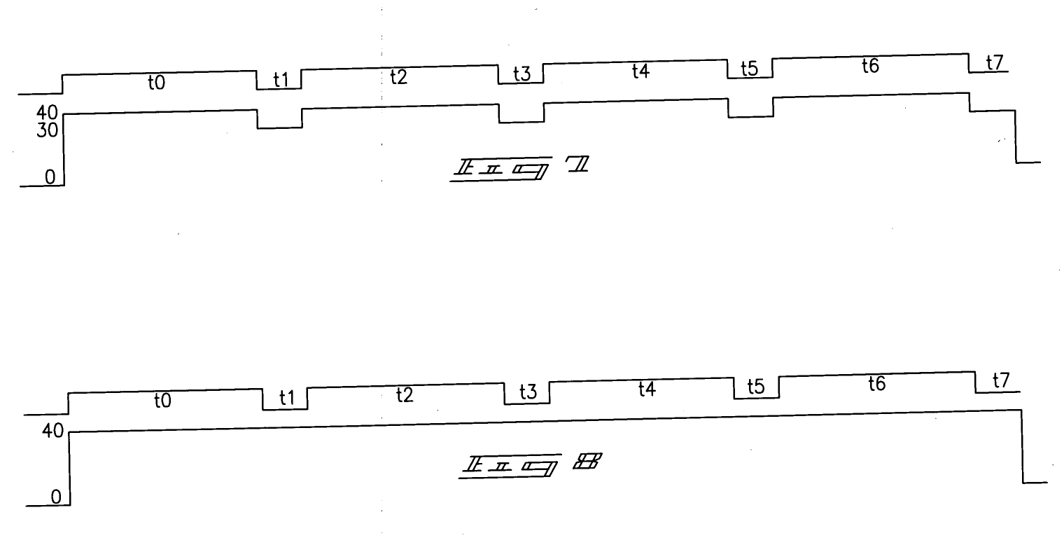

Referring now to FIG. 7, a graphical depiction of the power output that might be provided by a power system which does not include the teachings of the present invention is illustrated, and wherein the power system providing this output voltage includes four DC power sources each producing approximately 10 volts each collectively, these four sources provide 40 volts DC to the load. As should be understood, individual DC power sources are electrically decoupled from the load at time intervals T1, T3 and T5. This decoupling of one of the sources of DC power from the load produces a ripple, variation or power interruption of 10 volts, as it were, in the electrical power output provided to the load. As should be understood, this may be an unacceptable electrical power output for certain types of equipment which must have a substantially continuous and smooth electrical power supply. As seen in that view, at time intervals T2, T4 and T6, all four DC power sources are supplying electrical power to the load. Therefore, the load is receiving an electrical output of 40 volts.

FIG. 8 is a depiction of a DC power output provided by the present invention 10. As seen at time intervals T1, T3 and T5, respectively, individual DC power sources 11-14, respectively are individually decoupled from the load 30. However, during the same time interval (T1; T3; and T5), the controller 40 is operable to electrically discharge the charge storage device 60 in a fashion so as to provide an amount of electrical power (10 V) which is equal to that which was previously supplied by the decoupled DC power source. The power from the charge storage device 50 is provided to the load 30 in a fashion which prevents any ripple or disruption from being experienced by the load 30. The load 30 therefore receives a constant 40 volts notwithstanding the decoupling of the individual DC power sources 11-14. Referring now to FIG. 2, and FIG. 8, and in a first electrical state, and at time T0, or the initial state, it will be understood that the electrical switches identified as SW1, SW3, SW4, SW6, SW8 and SW10 are closed by the controller 40, and further, electrical switches SW5, SW7, SW9 and SW11 are electrically opened by the same controller. In this first electrical state, the charge storage device 60 is charged to about 10 volts. As should be understood, this voltage is about equal to the DC power output of at least one of the plurality of DC power sources 11-14, respectively. The voltage output of the power system 10 as seen and illustrated in FIG. 2 is approximately 40 volts, that being, the sum of the DC voltage output of the 4 DC power sources 11-14, respectively.

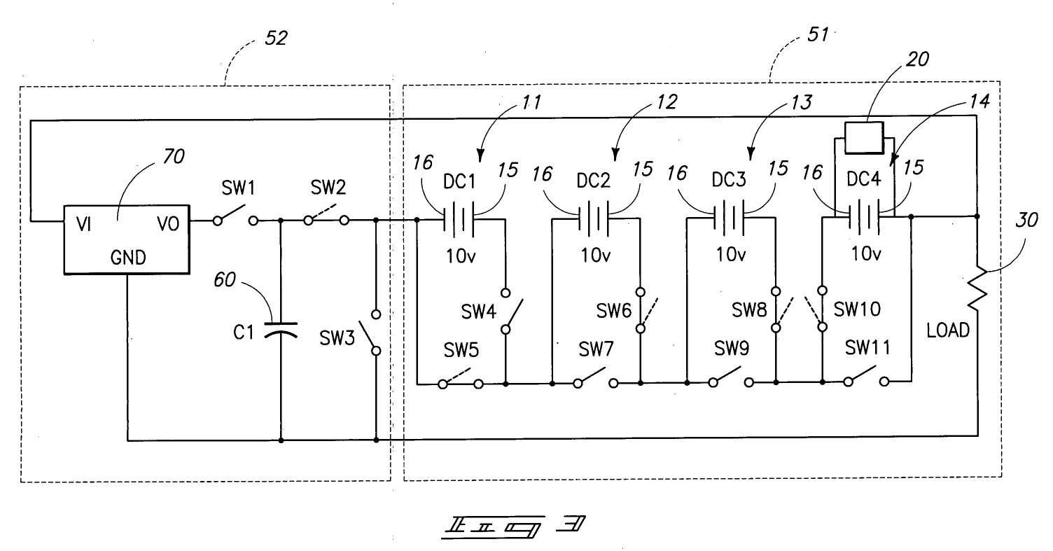

Referring now to FIG. 3, a second electrical state of the power system 10 is shown, and wherein at time period T1 as seen in FIG. 8, a single DC power source 11 is electrically decoupled from the load 30 by the controller 40. In order to achieve this electrical state, electrical switches SW1, SW3, SW4, SW7, SW9, and SW11 are opened and electrical switches SW2, SW5, SW6, SW8 and SW10 are closed by the controller 40. The voltage output as provided by the power system 10 is 40 volts, that being, the sum of the DC power sources 12, 13 and 14, respectively and the DC power output of the charged storage device 60 which is electrically discharged by the controller 40 for the time period during which the DC power source 11 is electrically decoupled from the load 30. During time period T2, the circuitry 51 and 52 and the respective switches referenced above revert by means of the controller 40 to the initial or first electrical state as seen in FIG. 2, and wherein all four DC power sources are collectively supplying power to energize the load 30, and the charge storage device is being electrically charged and readied for another electrical discharge.

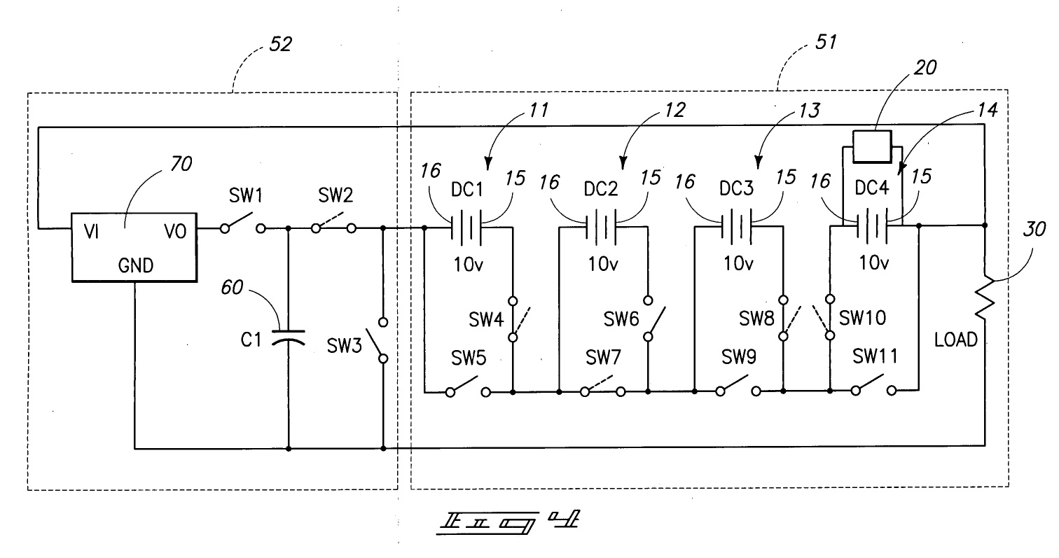

Referring now to FIG. 4, and FIG. 8, a third electrical state of the power system 10 is shown at time period T3, and wherein a single DC power source, here indicated as the second DC power source 12, is electrically decoupled from the load 30 by the controller 40. In this regard, the electrical switches SW1, SW3, SW5, SW6, SW9, and SW11 are electrically opened; and electrical switches SW2, SW4, SW7, SW8 and SW10 are electrically closed by the same controller 40. The voltage output which is provided to the load 40 remains at 40 volts and which is equal to the sum of the DC power output of the first, third and fourth DC power sources 11, 13 and 14, respectively, and the electrical power provided by the charge storage device 60. As will be appreciated, during time period T4, the power system 10 and all the above discussed electrical switches return to the first electrical state as shown in FIG. 2, and wherein the charging circuit 70 is operable to charge the charge storage device 60 with an amount of electricity from the DC power sources 11-14 thereby returning the charge storage device to a state where it can be selectively discharged by the controller 40 during another cycle, and the four DC power sources 11-14 are supplying electrical power to energize the load 30.

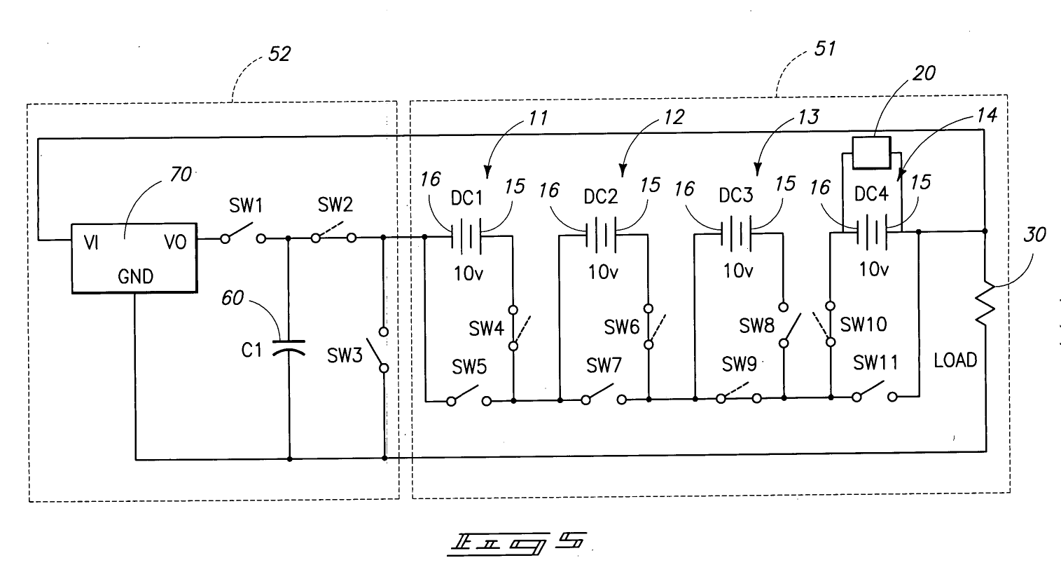

Referring now to FIG. 5, the power system 10 is shown in a fourth electrical state during time period T5, and wherein a single DC power source here shown as 13 is electrically decoupled from the load 30 by the controller 40. In this third electrical state, electrical switches SW1, SW3, SW5, SW7, SW8 and SW11 are opened; and electrical switches SW2, SW4, SW6, SW9, and SW10 are closed by the same controller. As with the previous examples, the voltage output of the power system 10 during this fourth electrical state equals 40 volts, that being, the sum of the electrical power outputs of the first, second and fourth DC power sources 11, 12 and 14, respectively, and the electrical power output provided by the charge storage device 60, and which is selectively discharged by the controller 40 during the time period T5 as seen in FIG. 8. Again, at time period T6 as seen in FIG. 8, the power system 10 of the present invention returns to the electrical state as seen in FIG. 2 under the influence of controller 40, and wherein the charging circuit 70 is operable to impart an electrical charge to the charge storage device 60 thereby rendering it capable of delivering an electrical discharge of 10 V during the next cycle.

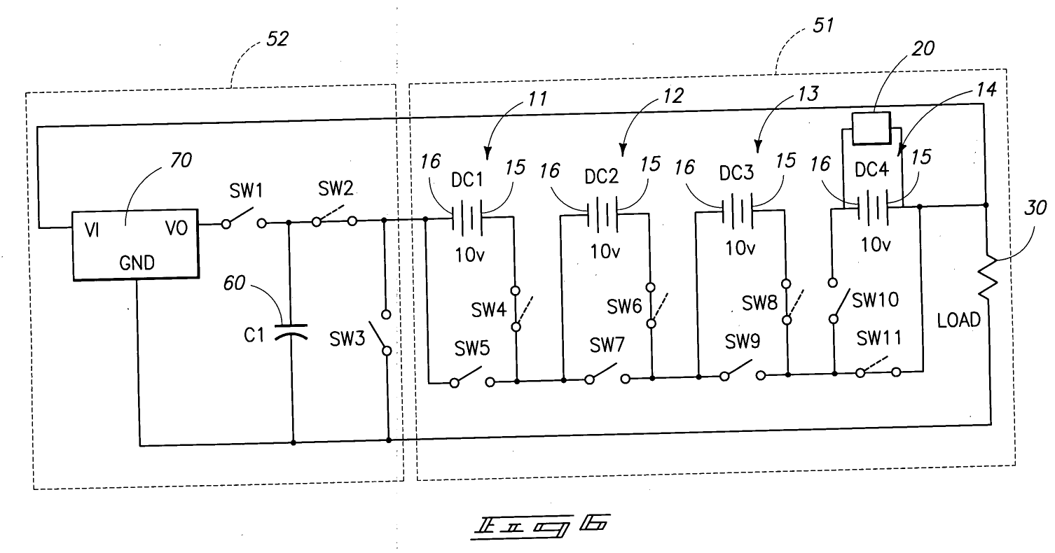

As seen in FIG. 8 and referring now to FIG. 6, the power system 10 of the present invention includes a fifth electrical state during time period T7, and wherein the fourth DC power source 14 is electrically decoupled from the load 30 by the controller 40. In this electrical state, electrical switches SW1, SW3, SW5, SW7, SW9, and SW10 remain electrically open; and electrical switches SW2, SW4, SW6, SW8 and SW11 are electrically closed by the same controller. Again, the voltage output as experienced by the load 30 remains 40 volts, that is, the sum of the DC power output of the three DC power sources 11, 12, and 13, respectively, and the voltage provided by the charge storage device 60 which is electrically discharged by the controller 60 during the time period T7. Again, after the time period T7, the fourth DC power source is again electrically coupled to the load, and the power system 10 is operable by means of the controller to return to the first electrical state as seen in FIG. 2. In the first electrical state, the charging circuit 70 is operable to electrically charge the charge storage device 60 thereby rendering it available to electrically discharge during another cycle as previously described.

### Operation

The operation of the described embodiment of the present invention is believed to be readily apparent and is briefly summarized at this point.

As best understood by a study of FIGS. 1, a power system 10 is disclosed and which includes a plurality of DC power sources 11-14, respectively such as a plurality of fuel cells, and wherein each of the DC power sources have a predetermined electrical power output, and which are serially electrically coupled together to produce a cumulative power output which substantially meets the electrical power requirements of the load 30. A controller 40 is provided and which is electrically coupled with the respective plurality of DC power sources 11-14, which may include a plurality of fuel cells, and which periodically electrically decouples the individual fuel cells from the load. Still further, the power system 10 includes a charge storage device 60 which is electrically coupled with the controller, and which is selectively electrically coupled to the load 30 when the controller decouples one of the plurality of DC power sources 11-14 from the load 30. The charge storage device 60 provides an amount of electrical power to the load 30 which is not greater than the electrical power output of the decoupled individual DC power sources 11-14. In the arrangement as seen, the controller 40 couples the charge storage device 60 to the load 30 in a manner wherein the load experiences substantially no interruption or reduction in the electrical power being supplied to same. This is best seen in FIG. 8.

In the arrangement as seen in FIGS. 2 and following, first circuitry 51 is provided and which couples the plurality of fuel cells 11-14 to the load 30. Still further, the power system 10 includes second circuitry 52 which is electrically coupled to the first circuitry 51, and which delivers a portion of the electrical power output of the respective fuel cells 11-14 to electrically charge the charge storage device 60 while the first circuitry 51 delivers the electrical power to meet the power requirements of the load 30. In the arrangement as seen in FIG. 1, the controller 40 is coupled in electrical power sensing relation relative to the respective plurality of DC power sources 11-14, respectively and the charge storage device 60. The controller is further controllably electrically coupled with the electrical switches SW1-SW11, respectively. As should be understood, the power system 10 of the present invention may be utilized with a plurality of fuel cells which each have an anode 15 and a cathode 16, and which, when rendered operable, supply electrical power of a given amount to meet the electrical power requirements of the load 30. In the arrangement as illustrated, and when a plurality of fuel cells are utilized as the DC power sources 11-14, the controller 40 is electrically coupled to the anode and cathode of each of the fuel cells and which is operable to periodically shunt the anode and cathode of each of the respective fuel cells by utilizing the shunt control circuitry 20 as indicated in FIGS. 1 and 2. Upon accomplishing the shunting, the respective DC power sources or fuel cells 11-14 in this case, results in a reduced amount of electrical power provided to the load 30. In this arrangement, a charge storage device 60 is provided, and which is controlled by the controller 40, and which is periodically electrically coupled to the load 30 during the shunting of the respective fuel cells, and which is operable to deliver electrical power which is substantially equal to the reduced amount of electrical power as caused by the shunting. In this arrangement as described, the electrical power output of the plurality of fuel cells is further utilized to charge the charge storage device during time periods between the shunting. As earlier discussed, the charge storage device 10 may comprise a plurality of ultracapacitors.

The present invention also relates to a method for supplying electrical power to a load 30 and which includes, in its broadest sense, the steps of providing a plurality of serially electrically coupled DC power sources 11-14 which individually produce an electrical power output; periodically removing the electrical power output of at least one of the DC power sources 11-14; and replacing the electrical power output which has been removed with another source of DC electrical power, such as provided by a charge storage device 60, in a fashion such that the electrical power supplied to the load 30 is substantially uninterrupted. In the methodology as described above, the method further includes the steps of sensing the electrical power output of the respective DC power sources by means of a controller 40, and providing a charge storage device 60 which is further electrically coupled with the controller. The method further includes the step of electrically charging the charge storage device 60 by means of a charging circuit 70, and which is supplied with the electrical power from of the plurality of DC power sources 11 and 14, respectively. Still further, the methodology includes the step of sensing the electrical charge of the charge storage device 60 by means of the controller 40; and electrically discharging the charge storage device 60 to replace the electrical power output of one of the DC power sources 11-14 which has been removed or electrically decoupled from the load 30.

More specifically, the methodology for supplying electrical power to a load 30 includes the steps of providing a plurality of DC power sources 11-14 which may include a plurality of fuel cells, and which individually produce an electrical power output; and serially electrically coupling the plurality of fuel cells together to provide a resulting electrical power output which is not greater than the electrical power requirements of the load 30. The methodology as described above includes a further step of supplying the resulting electrical power output of the serially electrically coupled DC power sources or fuel cells 11-14 to the load 30. Still further, the methodology includes a step of providing a controller 40 which is controllably electrically coupled to the respective plurality of DC power sources 11-14. Still further, the methodology includes a step of periodically electrically decoupling at least one of the plurality of DC power sources 11-14 from the plurality of serially electrically coupled DC power sources 11-14 with the controller 40. Additionally, the methodology includes the step of providing a charge storage device 60 which is selectively electrically coupled with the resulting electrical power output provided by the plurality of DC power sources, and which may include a plurality of fuel cells, and the load 30. As described herein, this step includes a further step wherein the charge storage device 60 is controllably electrically coupled with the controller 40. The methodology as described includes a further step of electrically charging the charge storage device 60 by use of a charging circuit 70 with the resulting electrical power output as provided by the plurality of DC power sources 11-14 while the plurality of DC power sources simultaneously meet the electrical power requirements of the load 30. The methodology as described further includes a step of electrically discharging the charge storage device 60 during a time period where the controller 40 has electrically decoupled at least one of the DC power sources from the plurality of DC power sources, and wherein the charge storage device 60 is discharged to provide electrical power in an amount which is substantially equal to the electrical power output of the electrically decoupled DC power source.

Therefore it will be seen that the present invention provides a convenient means whereby individual DC power sources may be selectively electrically decoupled from a load in a fashion whereby the resulting electrical power supplied to the load is substantially maintained without any ripple or significant interruption of any kind.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A power system, comprising:
a plurality of serially electrically coupled DC power sources each having an electrical power output which is supplied to a load;
a charge storage device electrically coupled with the plurality of DC power sources, and having a maximum electrical charge which is substantially equal to the electrical power output of one of the plurality of DC power sources; and
means for electrically decoupling at least one of the plurality of DC power sources-while simultaneously electrically discharging the charge storage device to the load.

2. A power system as claimed in claim 1, and wherein the plurality of DC power sources have substantially the same electrical power outputs.

3. A power system as claimed in claim 1, and wherein the plurality of DC power sources have different electrical power outputs.

4. A power system as claimed in claim 1, and wherein the plurality of DC power sources comprise a plurality of fuel cells which have substantially the same electrical power output.

5. A power system as claimed in claim 1, and wherein the plurality of DC power sources comprise a plurality of fuel cells which have different electrical power outputs.

6. A power system as claimed in claim 1, and wherein the charge storage device includes a plurality of charge storage devices, and wherein the means for electrically decoupling the plurality of DC power sources electrically decouples a plurality of the DC power sources from the load while simultaneous electrically discharging a number of charge storage devices having a cumulative electrical charge which is substantially equal to the cumulative electrical power output previously provided by the electrically disconnected DC power sources.

7. A power system as claimed in claim 1, and wherein the charge storage device comprises a battery.

8. A power system as claimed in claim 1, and wherein the charge storage device comprises an ultracapacitor.

9. A power system as claimed in claim 1, and further comprising:
first circuitry for serial electrically coupling the plurality DC power outputs of the plurality of DC power sources to the load, and wherein the circuitry is further operable to selectively electrically disconnect individual DC power sources from the load; and
second circuitry electrically coupled to the first circuitry and which supplies a portion of the DC power output provided by the plurality of DC power sources to electrically charge the charge storage device, and which electrically discharges the charge storage device when at least one of the plurality of DC power sources is electrically disconnected from the load.

10. A power system as claimed in claim 9, and wherein the means for electrically decoupling the individual DC power sources comprises a controller which is electrically coupled with the first and second circuitry, and which is further electrically coupled in electrical charge sensing relation relative to the charge storage device, and electrical power sensing relation relative to the respective DC power sources.

11. A power system, comprising:
a plurality of DC power sources which provide a source of electrical power to service a requirement of a load;
a charge storage device having a maximum electrical charge which is less than the amount of electrical power which is necessary to service the requirement of the load; and
means for selectively decoupling the individual DC power sources from the load while simultaneously electrically discharging, and electrically coupling the charge storage device to the load in a manner which provides uninterrupted electrical power to meet the electrical power requirement of the load.

12. A power system as claimed in claim 11, and wherein the respective plurality of DC power sources each produce an electrical power output, and wherein the maximum electrical charge of the charge storage device is substantially equal to the electrical power output of the DC power source which has been selectively decoupled from the load.

13. A power system as claimed in claim 11, and wherein the charge storage device comprises a plurality of charge storage devices, and wherein the respective plurality of DC power sources each produce an electrical power output, and wherein the means for selectively decoupling the individual DC power sources from the load simultaneously electrically discharges a plurality of charge storage devices which have a cumulative electrical charge which is substantially equal to the electrical power output of the DC power source which has been selectively disconnected from the load.

14. A power system as claimed in claim 11, and further comprising:
first circuitry which serially electrically couples the plurality of DC power sources to the load, and wherein the plurality of DC power sources have substantially similar electrical power outputs.

15. A power system as claimed in claim 11, and further comprising:
first circuitry which serially electrically couples the plurality of DC power sources to the load, and wherein the plurality of DC power source have dissimilar electrical power outputs.

16. A power system as claimed in claim 11, and further comprising:
first circuitry which serially electrically couples the plurality of DC power sources to the load; and
second circuitry, electrically coupled with the first circuitry, and which electrically charges and discharges the charge storage device, and wherein the first and second circuitry are controllably electrically coupled with the means for selectively electrically decoupling the individual DC power sources.

17. A power system as claimed in claim 16, and wherein the plurality of DC power sources comprise a plurality of fuel cells which each have an anode and a cathode, and wherein the means for selectively electrically decoupling the individual DC power sources comprises a controller which selectively shunts the anode to the cathode of at least one of the plurality of DC power sources, and wherein the controller is controllably electrically coupled to the first and second circuitry.

18. A power system as claimed in claim 11, and wherein the charge storage device is selected from the group which comprises a battery and an ultracapacitor.

19. A power system, comprising:
a plurality of fuel cells each having a predetermined electrical power output, and which are serial electrically coupled together, and which produce a cumulative power output which substantially meets the electrical power requirements of the load;
a controller which is electrically coupled with the respective plurality of fuel cells, and which periodically electrically decouples individual fuel cells from the load; and
a charge storage device which is electrically coupled with the controller, and which is selectively electrically coupled to the load when the controller electrically decouples one of the plurality of fuel cells from the load, and wherein the charge storage device provides an amount of electrical power to the load which is not greater than the electrical power output of the decoupled fuel cell.

20. A power system as claimed in claim 19, and wherein the controller electrically couples the charge storage device to the load in a manner wherein the load experiences substantially no interruption in the electrical power being supplied to same.

21. A power system as claimed in claim 19, and further comprising:
first circuitry for serially electrically coupling the plurality of fuel cells to the load; and
second circuitry electrically coupled to the first circuitry, and which delivers a portion of the electrical power output of the respective fuel cells to charge the charge storage device while the first circuitry delivers the electrical power to meet the power requirements of the load.

22. A power system as claimed in claim 19, and wherein the controller is coupled in electrical power sensing relation relative to the respective plurality of fuel cells and the charge storage device.

23. A power system, comprising:
a plurality of fuel cells which each have an anode and a cathode, and which, when rendered operable, supply electrical power of a given amount to meet the electrical power requirements of a load;
a controller electrically coupled to the anode and cathode of each of the fuel cells, and which is operable to periodically shunt the anode to the cathode of each of the respective fuel cells, and wherein the shunting of the respective fuel cells results in a reduced amount of electrical power provided to the load; and
a charge storage device which is controlled by the controller and which is periodically electrically coupled to the load during the shunting of the respective fuel cells, and which is operable to deliver electrical power which is substantially equal to the reduced amount of electrical power as caused by the shunting.

24. A power system as claimed in claim 23, and wherein the electrical power output of the plurality of fuel cells is utilized to charge the charge storage device.

25. A power system as claimed in claim 23, and wherein the charge storage device comprises a plurality of ultracapacitors.

26. A method for supplying electrical power to a load, comprising:
providing a plurality of serially electrically coupled DC power sources which individually produce an electrical power output;
periodically removing the electrical power output of at least one of the DC power sources; and
replacing the electrical power output which has been removed, with another source of DC electrical power in a fashion such that the electrical power supplied to the load is substantially uninterrupted.

27. A method as claimed in claim 26, and further comprising:
sensing the electrical power output of the respective DC power sources;
providing a charge storage device;
electrically charging the charge storage device with the electrical power output of the plurality of DC power sources;
sensing the electrical charge of the charge storage device; and
electrically discharging the charge storage device to replace the electrical power output of one of the DC power sources which has been removed from the load.

28. A method of supplying electrical power to a load, comprising:
providing a plurality of fuel cells which individually produce an electrical power output;
serially electrically coupling the plurality of fuel cells together to provide a resulting electrical power output which is not greater than the electrical power requirements of a load;
supplying the resulting electrical power output of the serially electrically coupled fuel cells to the load;
providing a controller which is controllably electrically coupled to the respective plurality of fuel cells;
periodically electrically decoupling at least one of the fuel cells from the plurality of serially electrically coupled fuel cells with the controller;
providing a charge storage device which is selectively electrically coupled with resulting electrical power output of the plurality of fuel cells, and the load, and which is controllably electrically coupled with the controller;
electrically charging the charge storage device to a maximum charge with the resulting electrical power output while the plurality of fuel cells simultaneously meet the electrical needs of the load; and
electrically discharging the charge storage device during a time period where the controller has electrically decoupled at least one of the fuel cells from the load, and wherein the discharged charge storage device provides electrical power to the load in an amount which is substantially equal to the electrical power output of the electrically decoupled fuel cell.
